(19) United States
(12) Patent Application Publication
(10) Pub. No.: US 2002/0098856 A1
(43) Pub. Date: Jul. 25, 2002

(54) Method and apparatus for sending out short messages from a mobile terminal in a mobile radio network

(76) Inventors: Andreas Berg, Berlin (DE); Ronald Heine, Fredersdorf (DE)

Correspondence Address: BELL, BOYD & LLOYD, LLC, P. O. BOX 1135, CHICAGO, IL, 60690-1135, US

(21) Appl. No.: 10/011,162

(22) Filed: Dec. 5, 2001

(30) Foreign Application Priority Data
Dec. 5, 2000 (DE) 100 60 365.3
Oct. 1, 2001 (DE) 101 48 466.6

(51) Int. Cl. H04Q 7/20

(52) U.S. Cl. 455/466; 455/406; 455/408

(57) ABSTRACT

A method and system for sending out short messages from a mobile terminal in a mobile radio network, wherein the incoming/outgoing CAMEL application part interaction is suppressed at the mobile switching center, but the short message is processed in an IN-related manner at the short message service center. In the mobile originating (transmitting) case, the mobile switching center takes from the short message service the calling party address, and in the mobile terminating (receiving) case it takes the called party address and sends it, together with a transmitting/receiving indication, to the home location register of the terminal via an unstructured supplementary service data string.

### BACKGROUND OF THE INVENTION

In recent years, communication via mobile radio networks has become more and more popular. In spite of the cumbersome handling, asynchronous communication via so-called short messages has become especially widespread. On the other hand, the use of prepaid telephone cards in mobile radio telephones has become very popular in certain target groups, for example with young people or with subscribers who do not wish to make many calls but wish to be available at any time. However, it is not easily possible to combine both popular features, the billing for short messages is delayed so that in the past, bad surprises came later for so many prepaid customer (or the operator affected).

One possibility of implementing special services in mobile radio networks is given by the architecture of intelligent networks (specified in ITU Q.1200 et seq. Standards). In a special embodiment for GSM mobile radio networks, there is the so-called CAMEL (Customized Applications for Mobile network Enhanced Logic) standard which is explained in greater detail in GSM standards 02.78 and 03.78.

The manufacturers of intelligent networks (IN) are confronted by the network operators with the question how IN is supporting the Short Message Service (SMS), particularly in the context of a Prepaid Service (PPS). In most networks, the short message service is transparent; i.e., the Switching Subsystem (SSS) does not have a triggering mechanism which can inform in the IN about the Mobile Originating (MO) or Mobile Terminating (MT) of a short message.

Although there are proprietary solutions on the market (e.g., from switches of Release SR8 by Siemens, the CAMEL Subscription Information for MOCs O-CSI is used for an SMS trigger), these only operate correctly in fully integrated Siemens networks. If a short message is started in an overlay network in the area of a mobile switching center (MSC) of another manufacturer, it is a matter of whether the other manufacturer offers an SMS trigger or not.

Short message service centers (SMSC) are central points in a network for short messages. This should be the starting point for a solution acceptable to the network operator for a closed concept for SMS MO/MT.

For the near future, only a partial solution is known which, however, is only supported in CAMEL Phase 3. It contains an SMS MO trigger in the mobile service switching points (M-SSPs). For this purpose, an SMS CSI (Camel Subscription Information) which includes the usual CSI data such as address of the service control point (SCP), service key, etc., is administered in the home location register (HLR). This is nice, but unfortunately too late and incomplete. An SMS MT trigger is included in CAMEL Phase 4, at the earliest.

Previous solutions are proprietary (see above, SR8 SMS MO trigger via O-CSI) or a so-called “Warm Billing”: billing systems of the network operator collect SMS charge tickets of an end user and send them “en block” via volume data interfaces to the “correct” SCP where a “negative recharge” is performed. The negative effects of this method are known since the costs for short messages reached high amounts and end users at the SCP virtually slip deep into red figures. The control of a prepaid system is carried out ad absurdum in such cases.

A method for sending out short messages is already known from the post-published patent application DE 10059647.

It is an object of the present invention, therefore, to offer a solution for billing for the short message service, particularly in the case of prepaid billing, which avoids the abovementioned disadvantages.

### SUMMARY OF THE INVENTION

In the method according to the present invention, the MO/MT CAP (CAMEL Application Part) dialog is suppressed at the SMSC (either because the SMSC does not have an SSP or because the subscriber is not allocated an SMS-CSI) but the SMS is processed with respect to the IN at the SMSC. In the mobile originating case (MO), the SMSC takes from the SMS the calling party address CgPA and in the mobile terminating case (MT) it takes the called party address CdPA and sends it together with an MO/MT indication to the home location register HLR of the mobile station via a USSD string (compare GSM 02.90, GSM 02.30).

Advantages:

The new solution does not place the IN handling scattered over the network at all M-SSPs or GSNs (Group Switching Network) but centrally at the short message service centers (SMSCs).

The SMSC acts in such a manner that adaptations to the other network elements are minimized or are not necessary at all.

Instead of “Warm Billing,” charges for short messages can be directly billed.

This is a uniform solution for MO short messages and for MT short messages.

Conversion and implementation of CAMEL Phase 3 and 4 is too late by years for most network operators. They need a network-compatible and fast solution now.

The SMSC starts an MO/MT-specific USSD string which is forwarded from the HLR to the “correct” service control point SCP via U(G)-CSI. The string contains the MSISDN (Mobile Subscriber ISD Number) of the calling party.

A few SMSCs take over the role of the numerous M-SSPs or GSNs.

The existing databases in the network, the home location registers (HLRs), are used instead of implementing further new databases.

Additional features and advantages of the present invention are described in, and will be apparent from, the following Detailed Description of the Invention and the Figures.

### BRIEF DESCRIPTION OF THE FIGURES

FIG. 1 shows the mobile originating (MO) and the mobile terminating (MT) of a short message.

### DETAILED DESCRIPTION OF THE INVENTION

MO “*123 *491729876543#” (MO indicator: “*” as separator)

MO “*123 #491729876543#” (MO indicator: “#” as separator)

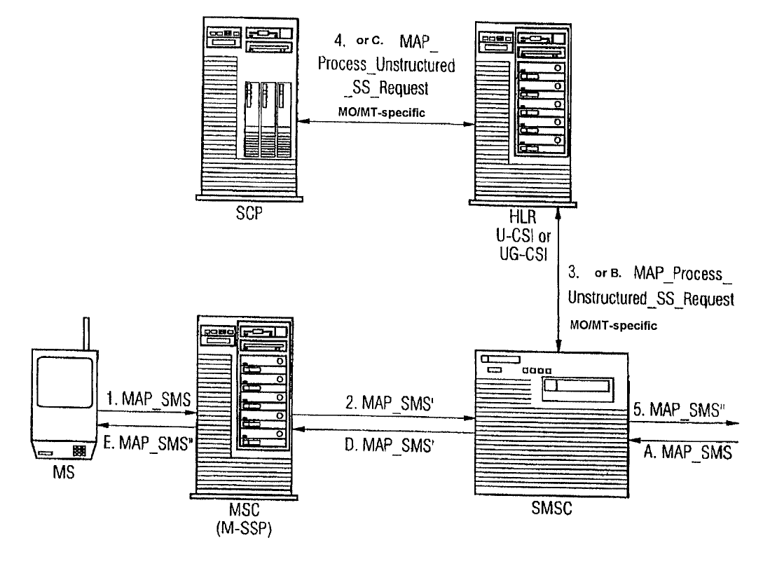

FIG. 1 shows the sequence according to the present invention, both the mobile originating case (steps 1 to 5) and the mobile terminating case (MT, steps A to E). The short message affected first reaches the short message service center (SMSC, MO case: steps 1, 2, MT case: step A). The short message service center sends a message (USSD) (Unstructured Supplementary Service Data) to the home location register (step 3 or B).

At the home location register (HLR), the USSD string encounters either a U(G)-CSI or not (U-CSI: subscribed USSD string, UG-CSI: dialed CSI string). In the first case, the home location register (HLR) forwards the USSD string to the “correct” service control point (SCP) (Step 4 or C). (At the SCP, the subscriber already may be able to address his/her prepaid service via UCB. The USSD service code, “123” in the example, must differ from other service codes.)

The service control point (SCP) can now identify and execute the IN processing via the service code. In most cases, this is the prepaid service: after checking the authenticity and subtracting the price for the short message SMS, the service control point (SCP) returns a reply USSD string which is understood as “continue” or “release” by the short message service center SMSC.

Example:

MO “*123 *CON491729876543#”

MO “*123 #RREL491729876543#”

In the second case (the subscriber does not have a U-or UG-CSI), the home location register HLR does not recognize the service code and responds with an error message (provider error “service not supported” or user error “unexpected data value”). For the SMSC, this is an indication to use the usual (non-IN) procedure.

For security reasons, the USSD string sent by the short message service center SMSC should contain characters which can be written only with difficulty or, at best, not at all by personal transmitters. Otherwise, to cause damage to another mobile radio subscriber, a user of the security gap could unrestrictedly start USSD strings which reduce the prepaid account of the first mobile radio subscriber without the latter having used the short message service.

At present, no mobile telephone is known which allows escape into the letter mode when writing a USSD string.

The character set which can be used in a mobile telephone is described in GSM 03.38. All characters of the 7-bit GSM default alphabet described there are used for SMS in a commercially available mobile station such as the Siemens S25, with the exception of the 7-bit GSM default alphabet extension tables, namely: ˆ , {,}, \, [,˜,], |. Since it cannot be excluded that these characters, too, will be available at some time, they are also eliminated.

One possible solution is to use the escape character to the extension table (coding: b1=1, b2=1, b3=0, b4=1, b5=1, b6=0, b7=0) in a special form which cannot come from a mobile telephone; e.g., without subsequent characters or immediately before the final ‘#’ or twice in succession. The SCP can see from this peculiarity that this is not an attempted fraud/fake.

A short message service center should not initiate the MT procedure described if the short message SMS comes from a personal transmitter: in this case SMS is free for the recipient in Germany at the present time. Only short messages from content providers (such as, e.g., Dr. Matema) are to be billed and must, therefore, be recognizable as such for the short message service center.

Although the present invention has been described with reference to specific embodiments, those of skill in the art were recognized that changes may be made thereto without departing from the spirit and scope of the invention as set forth in the hereafter appended claims.

1. A method for sending out and receiving short messages from a mobile terminal in a mobile radio network, the method comprising the steps of:
receiving a short message by a short message service center;
taking from the short message, by the short message service center, a mobile address;
generating via the short message service center, a message which contains the mobile address and a service code;
sending, via the short message service center, the message to a home location register; and
receiving, by the short message service center, as an answer from the home location register a further message based on which the short message transmission is continued or discontinued.

2. A method for sending out and receiving short messages from a mobile terminal in a mobile radio network, the method comprising the steps of:
receiving a message, at a home location register, from a short message service center which contains at least a service code and a mobile address from the short message to be sent out;
forwarding the messages, via the home location register, to a service control point;
receiving, at the home location register, an answer from the service control point; and
sending, via the home location register, the answer back to the short message service center.

3. A method for sending out and receiving short messages from a mobile terminal in a mobile radio network, the method comprising the steps of:
receiving a message, at a service control point, from a short message service center via a home location register, the message containing at least a service code and a mobile address of the short message to be sent out;
processing the message, via the service control point, the processing including checking an authenticity of a sender and generating a billing ticket for the message; and
sending back a further message, after successful processing and via the home location register, to the short message service center, the further message containing an instruction about the further processing of the short message to be sent out.

4. A method for sending out and receiving short messages from a mobile terminal in a mobile ratio network as claimed in claim 1, wherein the message contains characters which are not contained in a usable character set.

5. A method for sending out and receiving short messages from a mobile terminal in a mobile radio network as claimed in claim 2, wherein the message contains characters which are not contained in a usable character set.

6. A method for sending out and receiving short messages from a mobile terminal in a mobile ratio network as claimed in claim 3, wherein the message contains characters which are not contained in a usable character set.

7. A method for sending out and receiving short messages from a mobile terminal in a mobile radio network as claimed in claim 1, wherein, where a short message is to be sent to a mobile terminal, processing of the short message, including billing, is performed differently depending on a sender.

8. A method for sending out and receiving short messages from a mobile terminal in a mobile radio network as claimed in claim 2, wherein, where a short message is to be sent to a mobile terminal, processing of the short message, including billing, is performed differently depending on a sender.

9. A method for sending out and receiving short messages from a mobile terminal in a mobile radio network as claimed in claim 3, wherein, where a short message is to be sent to a mobile terminal, processing of the short message, including billing, is performed differently depending on a sender.

10. A system for sending out and receiving short messages from a mobile terminal in a mobile radio network, comprising;
a home location register; and
a short message service center, wherein a short message is received by the short message service center, the short message service center takes from the short message a mobile address, the short message service center generating a message which contains the mobile address and a service code and then sending the message to the home location register, and the short message service center receiving as an answer from the home location register a message based on which the short message transmission is continued or discontinued.

11. A system for sending out and receiving short messages from a mobile terminal in a mobile radio network, comprising:
a short message service center;
a service control point; and
a home location register, wherein the home location register receives a message from the short message service center, the message containing at least a service code and a mobile address from the short message to be sent out, the home location register then forwarding the message to the service control point, receiving an answer from the service control point and sending the answer back to the short message service center.

12. A system for sending out and receiving short messages from a mobile terminal in a mobile radio network, comprising:
a short message service center;
a home location register; and
a service control point, wherein the service control point receives a message from the short message service center via the home location register, the message containing at least a service code and a mobile address of the short message to be sent out, the service control point then processing the message, including checking an authenticity of a sender, and generating a billing ticket for the message sent out and, after successful processing, sending back a further message via the home location register to the short message service center, the further message containing an instruction about the further processing of the short message to be sent out.
